(19) United States
(12) Patent Application Publication
(10) Pub. No.: US 2013/0035936 A1
(43) Pub. Date: Feb. 7, 2013

(54) LANGUAGE TRANSCRIPTION

(71) Applicants: Jacob B. Garland, Marietta, GA (US); Marsal Gavalda, Sandy Springs, GA (US)

(72) Inventors: Jacob B. Garland, Marietta, GA (US); Marsal Gavalda, Sandy Springs, GA (US)

(73) Assignee: Nexidia Inc., Atlanta, GA (US)

(21) Appl. No.: 13/564,112

(22) Filed: Aug. 1, 2012

Related U.S. Application Data
(60) Provisional application No. 61/514,111, filed on Aug. 2, 2011.

(51) Int. Cl. G10L 15/26

(52) U.S. Cl. 704/235; 704/E15.043

(57) ABSTRACT

A transcription system is applicable to transcription for a language in which there is limited pronunciation and/or acoustic data. A transcription station is configured using pronunciation data and acoustic data for use with the language. The pronunciation data and/or the acoustic data is initially from another dialect of a language, another language from a language group, or is universal (e.g., not specific to any particular language). A partial transcription of the audio recording is accepted via the transcription station (e.g., from a transcriptionist). One or more repetitions of one or more portions of the partial transcription are identified in the audio recording, and can be accepted during transcription. The pronunciation data and/or the acoustic data is updated in a bootstrapping manner during transcription, thereby improving the efficiency of the transcription process.

### CROSS-REFERENCE TO RELATED APPLICATIONS

This application claims priority to U.S. Provisional Application Ser. No. 61/514,111, filed Aug. 2, 2011, the contents of which are incorporated herein by reference.

### BACKGROUND

This invention relates to a system for transcription of audio recordings, and more particularly, to a system for transcription for audio spoken in a “new” language for which limited or no training material is available.

Manual transcription is often performed by a user listening to an audio recording while typing the words heard in the recording with relatively low delay. Generally, the user can control the audio playback, for example, using a foot control that can pause and rewind the audio playback. Some playback devices also enable control of the playback rate, for example, allowing slowdown or speedup by factors of up to 2 or 3 while maintaining appropriate pitch of recorded voices. The operator can therefore manually control playback to accommodate the rate at which they are able to perceive and type the words they hear. For example, they may slow down or pause the playback in passages that are difficult to understand (e.g., noisy recordings, complex technical terms, etc.), while they may speed up sections where there are long silent pauses or the recorded speaker was speaking very slowly.

One use of manual transcription is for training of speech recognition systems. For example, in order to apply a speech recognition system to a new language, it is generally necessary or useful to have at least some limited amount of transcribed training data that can be used to estimate parameters for acoustic models, typically of subword and/or phonetic units in the language. However, such transcription is time consuming. There is therefore a need to reduce the amount of human effort required in making a transcription of a new language in a manner that is suitable use in speech recognition training

### SUMMARY

In one aspect, in general, a method for transcribing audio for a language includes accepting an audio recording of spoken content from the language. Pronunciation data and acoustic data for use with the language are accepted, for example, to configure a transcription system. A partial transcription of the audio recording is accepted, for example, via the transcription system from a transcriptionist. One or more repetitions of one or more portions of the partial transcription are identified in the audio recording. A representation of the audio recording is presented, for example, via a user interface of the transcription system. The representation of the audio recording includes a representation of the partial transcription and a representation of the repetitions in the recording. A command is then accepted to indicate a repetition as a further partial transcription of the audio recording.

The method is particularly applicable to transcription for a language in which there is limited pronunciation and/or acoustic data. For example, the pronunciation data and/or the acoustic data are from another dialect of a language, another language from a language group, or are universal (e.g., not specific to any particular language).

The method can include, prior to completing transcription of the audio recording, using the partial transcription to update at least one of the pronunciation data and the acoustic data for use in further transcription of the audio data.

Timing of acoustic presentation of the audio recording can be controlled according to timing of the accepting of the partial transcription using the pronunciation data and the acoustic data for use with the language.

In another aspect, in general, a method for transcribing audio for a language includes accepting an audio recording of spoken content from the language, accepting pronunciation data and acoustic data for use with the language, accepting a partial transcription of the audio recording, identifying one or more repetitions of one or more portions of the partial transcription in the audio recording, presenting a representation of the audio recording, the representation of the audio recording including a representation of the partial transcription and a representation of the repetitions in the recording, and accepting a command to indicate at least one of the repetitions as a further partial transcription of the audio recording.

Aspects may include one or more of the following features.

The method may include a step for providing a user interface to a transcription system, and where the accepting of the partial transcription, presenting the representation of the audio recording, and/or accepting the command to indicate at least one of the repetitions are performed using the user interface. Accepting the pronunciation data and the acoustic data may include configuring a transcription system according to said data. The pronunciation data and/or the acoustic data may be associated with another dialect of a language, another language from a language group, or may not be specific to a language.

The method may include a step for, prior to completing transcription of the audio recording, using the partial transcription to update at least one of the pronunciation data and the acoustic data for use in further transcription of the audio data. The method may include as step for controlling timing of acoustic presentation of the audio recording according to timing of the accepting of the partial transcription using the pronunciation data and the acoustic data for use with the language.

In another aspect, in general, a system for transcribing audio for a language includes an input for accepting an audio recording of spoken content from the language, an input for accepting pronunciation data and acoustic data for use with the language, in input for accepting a partial transcription of the audio recording, a speech processor for identifying one or more repetitions of one or more portions of the partial transcription in the audio recording, a user interface module for presenting a representation of the audio recording, the representation of the audio recording including a representation of the partial transcription and a representation of the repetitions in the recording, and an input for accepting a command to indicate at least one of the repetitions as a further partial transcription of the audio recording.

Aspects may include one or more of the following features.

The system may include a user interface to a transcription system. The accepting of the partial transcription, presenting the representation of the audio recording, and/or accepting the command to indicate at least one of the repetitions may be performed using the user interface. Accepting the pronunciation data and the acoustic data may include configuring a transcription system according to said data. The pronunciation data and/or the acoustic data may be associated with another dialect of a language, another language from a language group, or may not be specific to a language.

The system may be configured to, prior to completing the transcription of the audio recording, use the partial transcription to update at least one of the pronunciation data and the acoustic data for use in further transcription of the audio data. The system may be configured to control timing of acoustic presentation of the audio recording according to timing of the accepting of the partial transcription using the pronunciation data and the acoustic data for use with the language.

In another aspect, in general, software stored on a computer-readable medium includes instructions for causing a data processing system to accept an audio recording of spoken content from the language, accept pronunciation data and acoustic data for use with the language, accept a partial transcription of the audio recording, identify one or more repetitions of one or more portions of the partial transcription in the audio recording, present a representation of the audio recording, the representation of the audio recording including a representation of the partial transcription and a representation of the repetitions in the recording, and accept a command to indicate at least one of the repetitions as a further partial transcription of the audio recording.

Aspects may include one or more of the following features.

The software may further include instructions for causing the data processing system to provide a user interface to a transcription system, and where the accepting of the partial transcription, presenting the representation of the audio recording, and/or accepting the command to indicate at least one of the repetitions may be performed using the user interface. The instructions for causing the data processing system to accept the pronunciation data and the acoustic data may include instructions for causing the data processing system to configure a transcription system according to said data.

The pronunciation data and/or the acoustic data may be associated with another dialect of a language, another language from a language group, or may not be specific to a language. The software may include instructions for causing the data processing system to, prior to completing transcription of the audio recording, use the partial transcription to update at least one of the pronunciation data and the acoustic data for use in further transcription of the audio data. The software may include instructions for causing the data processing system control timing of acoustic presentation of the audio recording according to timing of the accepting of the partial transcription using the pronunciation data and the acoustic data for use with the language.

Advantages of the approach include providing an effective and efficient way of bootstrapping a speech recognition system (e.g., a wordspotting system) to a new language.

Efficiency of transcription can improve incrementally as further partial transcription is obtained.

The transcription task can be distributed to multiple transcriptionists, with each benefiting from the partial transcription performed by others.

Other features and advantages of the invention are apparent from the following description, and from the claims.

### DESCRIPTION OF DRAWINGS

FIG. 1 is a block diagram of a transcription system.

FIG. 2 is an illustration of an automated transcription rate process.

FIG. 3 is an illustration of a predictive text transcription process.

FIG. 4 is a graphical user interface including a transcription template.

FIG. 5 is a graphical user interface configured to automatically fill in textual placeholders.

FIG. 6 is a graphical user interface configured to enable automated transcription that includes human input.

### DESCRIPTION

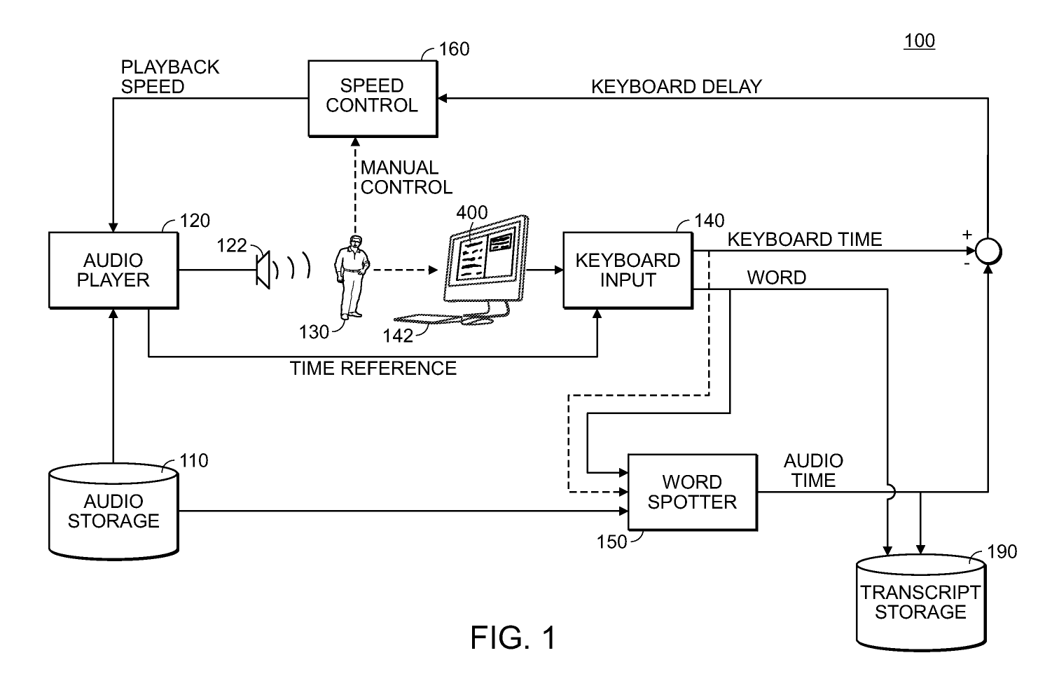

Referring to FIG. 1, a transcription system 100 provides a way of processing an audio recording stored in an audio storage 110 to produce a time referenced transcription stored in a transcription storage 190. The transcription is time referenced in that all (or most) of the words in the transcription are tagged with their time (e.g., start time, time interval) in the original recording. The system makes use of a user 130, who listens to the recording output from an audio player 120 (e.g., over a speaker or headphones 122) and enters a word-by-word transcription of what they hear into a keyboard input unit 140 (e.g., via a keyboard 142). In some examples, an optional graphical user interface 400 provides feedback to the user 130 for the purpose of improving the efficiency and quality of the transcription.

The keyboard input unit 140 receives a time reference from the audio player 120 so that as a word is entered by the user, the keyboard time of that entry in the time reference of the audio recording is output in association with each word that is typed by the user. The sequence of words typed by the user form the text transcription of the recording.

Generally, when the user types a word, that word was recently played by the audio player. Therefore, the keyboard time generally lags the audio play time by less than a few seconds. A precise audio time for each typed word is determined by passing the typed word (and optionally the keyboard time) to a word spotter 150, which processes a trailing window of the audio playback to locate the word. Generally the word is found (unless the user made a typing error or extraneous text was output), and the detected audio time is stored along with the typed word in the transcription storage.

The difference between the keyboard time and the earlier audio time represents the typing delay by the user. For example, if the user has difficulty in understanding or typing the words he hears, one might expect the delay to increase. In conventional transcription systems, the user may pause or even rewind the recording until he catches up. In the system 100 shown in FIG. 1, the keyboard delay is passed to a speed control 160, which adapts the playback speed to maintain a desired delay in a feedback approach. In this way, as the user slows down his typing, the playback naturally slows down as well without requiring manual intervention. Without having to control the player, the user may achieve a higher overall transcription rate.

In some examples, the user maintains the ability to manually control the audio playback. In some examples, they can also control a target or maximum delay. Furthermore, in some examples, the manual control makes use of the estimated audio times of previously transcribed words allowing the user to rewind a desired number of words, for example, to review and/or retype a section of the recording.

In some examples, the wordspotting procedure makes use of a technique described in U.S. Pat. No. 7,263,484, titled “Phonetic Searching,” which is incorporated herein by reference. The audio recording is processed to form a “PAT” file (which may be precomputed and stored with the audio recording), which includes information regarding the phonetic content at each time of the recording, for example, as a vector of phoneme probabilities every 15 ms. When transcribed words are entered by the user, they are compared against the PAT file to locate the spoken time.

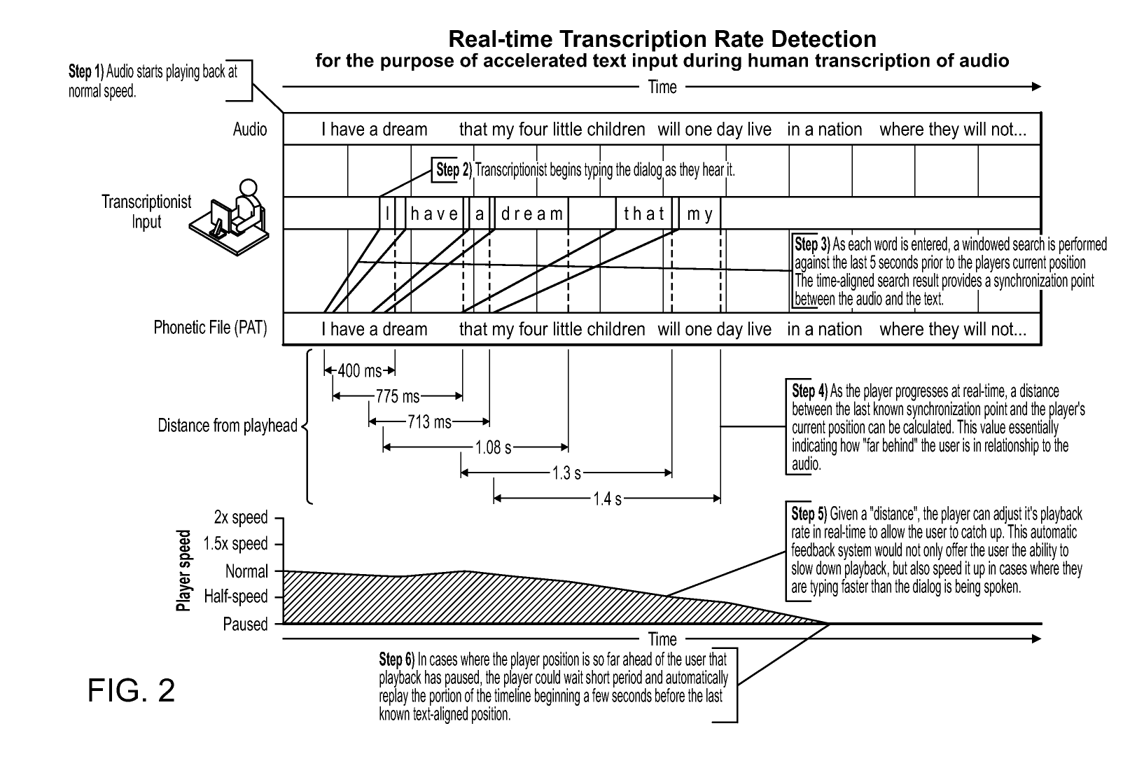

Referring to FIG. 2, an example of an automated transcription rate procedure is illustrated for an example in which the spoken words “I have a dream . . . ” are present on the audio recording. The procedure is illustrated as follows:

Step 1: Audio starts playing at normal speed

Step 2: The user (transcriptionist) begins typing the dialogue as they hear it.

Step 3: As each word in entered, a windowed search is performed against the last 5 seconds prior to the player's current position. The time-aligned search result process a synchronization point between the audio and the text.

Step 4: As the player progresses at real time, a distance (keyboard delay) between the last known synchronization point and the player's current position is calculated. This value essentially indicates how “far behind” the user is in relation to the audio.

Step 5: Given a “distance”, the player adjusts its playback rate (i.e., the speed control adjust the player's speed) to allow the user to catch up. This automatic feedback system not only offers the user the ability to slow down playback, but also to speed it up in cases where they are typing faster than the dialogue is being spoken.

Step 6: In cases where the player position is so far ahead of the user and the playback is paused, in some versions the player waits for a short period and automatically replay the portion of the timeline beginning a few seconds before the last known text-aligned position.

Another automated feature that can be used in conjunction with, or independently of, the automatic playback speed control relates to presenting predicted words to enable the user to accept words rather than having to type them completely.

There are two sources of information for the prediction. First, the transcription up to a current point in time provides a history that can be combined with a statistical language model to provide likely upcoming words. The second source of information is the upcoming audio itself, which can be used to determine whether the predicted upcoming words are truly present with a reasonably high certainty. One way of implementing the use of these two sources of information is to first generate a list of likely upcoming words, and then to perform a windowed wordspotting search to determine whether those words are truly present with sufficiently high certainty to be presented to the user as candidates. Other implementations may use a continuous speech recognition approach, for example, generating a lattice of possible upcoming word from the upcoming audio that has not yet been heard by the transcriptionist. Such a procedure may be implemented, for example, by periodically regenerating a lattice or N-best list, or pruning a recognition lattice or hypothesis stack based on the transcribed (i.e., verified) words as the user types them.

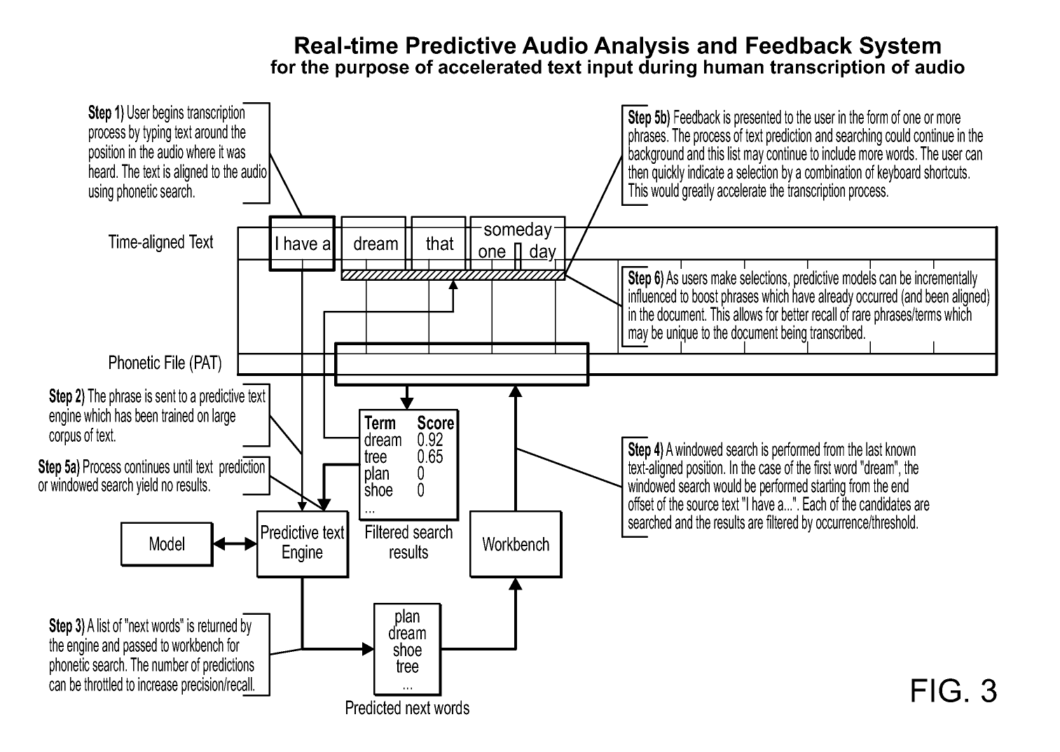

Referring to FIG. 3, an example of a predicted text transcription procedure is illustrated for the example in which the spoken words “I have a dream . . . ” are present on the audio recording. The procedure is illustrated as follows:

Step 1: The user begins the transcription process by typing text around the position in the audio where it was heard. The text is aligned to the audio, for example, using the audio search process as described above.

Step 2: The phrase entered by the user is sent to a predictive text engine, for example, which has been statistically trained on a large corpus of text.

Step 3: A list of “next words” is returned from the predictive text engine and passed to the phonetic search module. In some implementations, the number of predictions can be adjusted to vary the precision/recall tradeoff.

Step 4: A windowed search is performed from the last known text-aligned position. In the case of the first word “dream,” the windowed search would be performed starting from the end of the offset of the source text “I have a . . . ” . Each of the candidates are searched and the results are filtered by occurrence/threshold.

Step 5a: The process continues until text prediction or windowed search yield no results.

Step 5b: Feedback is presented to the user in the form of one or more phrases. In some versions, the process of text prediction and searching continues in the background and this list may continue to include more words. The user can quickly indicate a selection, for example, by a combination of keyboard shortcuts, which may greatly accelerate the transcription process.

In some examples, the prediction of upcoming words makes use of dictionary-based word completion in conjunction or independent of processing of upcoming audio. For example, consider a situation in which the user has typed “I have a dream”. The text prediction unit has identified “that one day”, which is found in the audio. Since the system knows the end position of “that one day” in the audio and the system is relatively certain that it occurs, the system optionally processes the audio just beyond that phrase for a hint as to what occurs next. Using an N-best-phonemes approach, the system maps the next phoneme (or perhaps 2-3 phonemes) to a set of corresponding characters. These characters could then be sent back to the text prediction unit to see if it can continue expanding. In this example, the next phonemes after “that one day” might be “_m” which maps to the character “m”. This is sent to the text-prediction engine and a list of words beginning with “m” is returned. The word “my” is found in the audio and then the suggested phrase presented to the user is now “that one day my”. This process can be repeated.

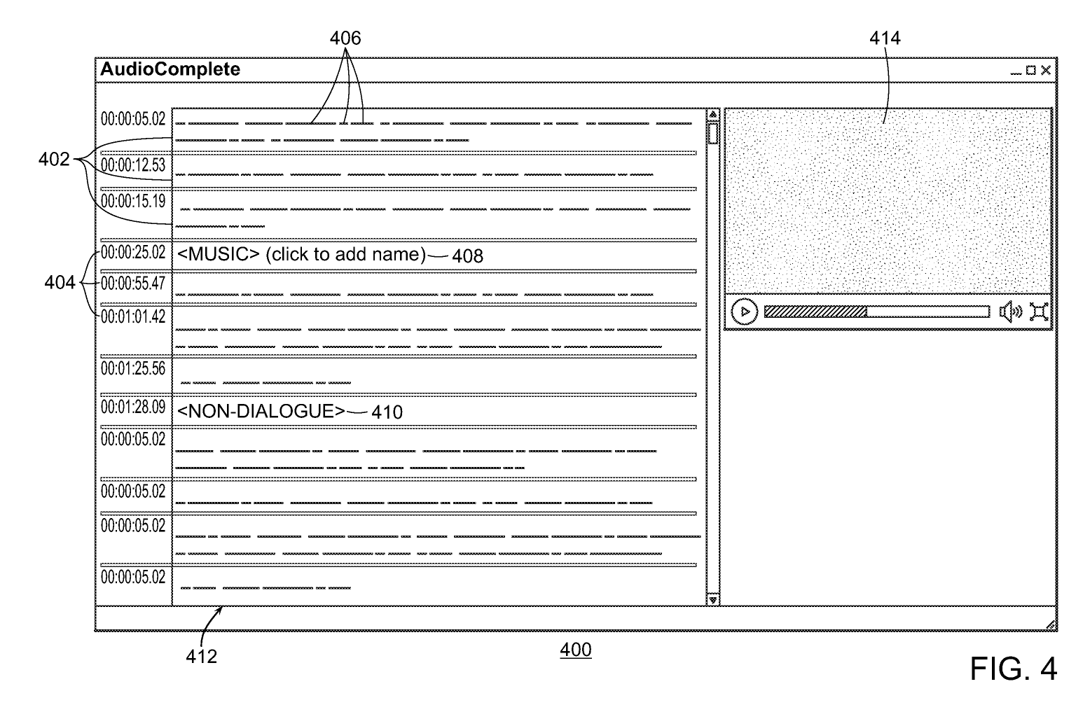

Referring to FIG. 4, in some examples, a visualization presented to the user represents the structure of the transcript as a “template” rather than a blank page. Through the use of various detectors (voice activity, silence, music, etc), the template is broken up into logical sections. Visualizing the transcript as a complete document can help the transcriptionist have a view of the context of the audio without actually knowing what is spoken in the audio.

Such a visualization is provided by a user interface 400 that can be provided as a front end to the transcription system described above. A transcriptionist can view the graphical user interface 400 on a display monitor and interface with the graphical user interface 400 using, for example, a keyboard and a mouse. One example of a graphical user interface 400 for transcribing an audio signal includes a transcription template 412 and a media player 414 which can be configured play back an audio or video signal to the transcriptionist. The transcription template 412 includes a sequence of “blocks” 402, each block associated with a timestamp 404 that indicates the time in the audio signal associated with the beginning of the block 402. Each block 402 has a time duration which is defined as the amount of time between the block's 402 timestamp 404 and a significantly long break in voice activity following the block's 402 timestamp 404. The time boundaries of the blocks 402 are determined by applying, for example, a voice activity detector on the audio signal. The voice activity detector monitors voice activity in the audio signal and when it detects a significant break in voice activity (e.g., >1 sec. of silence), the current block 402 is ended. A new block 402 beings when voice activity resumes.

At least some of the blocks 402 include a number of textual placeholders 406. Each textual placeholder 406 in a block 402 represents a word or phrase that is present in the audio signal. The combination of all of the textual placeholders 406 within the block 402 represents a textual structure of dialogue present in the audio signal over the duration of the block 402. In some examples, the textual placeholders 406 are displayed on the graphical user interface 400 as underscores with a length that indicates the estimated duration in time of a word or phrase represented by the textual placeholder 406.

The textual placeholders 406 are identified by detecting pauses between words and/or phrases in the audio signal. In some examples, the pauses are detected by identifying segments of silence that are smaller than those used to identify the boundaries of the blocks 402 (e.g., 200 ms. of silence). In other examples, an N-best-path approach can be used to detect pau (pause) phonemes in the audio signal.

In some examples, different types of blocks 402 can be used. For example, a music detection algorithm can be used to indicate portions of the audio signal that are musical (i.e., non-dialogue). The graphical user interface 400 can display a <MUSIC> block 408 that indicates a start time and duration of the music. A user of the graphical user interface 400 can edit metadata for the music block by, for example, naming the song that is playing.

Another type of block 402, a <NON-DIALOGUE> block 410 can indicate silence and/or background noise in the audio signal. For example, the <NON-DIALOGUE> block 410 may indicate a long period of silence, or non-musical background noise such as the sound of rain or machine noise.

In some examples, if the audio signal includes the dialogue of multiple speakers, a speaker identification or change detection algorithm can be used to determine which speaker corresponds to which dialogue. Each time the speaker detection algorithm determines that the speaker has changed, a new block 402 can be created for that speaker's dialogue.

In some examples advanced detectors like laughter and applause could also be used to further create blocks 402 that indicate key points in the audio signal.

In operation, when an audio signal is loaded into the transcription system, underlying speech recognition and wordspotting algorithms process the audio signal to generate the transcription template 412. The template 412, in conjunction with the previously described automatic control of audio signal playback speed can assist a transcriptionist in efficiently and accurately transcribing the audio signal. For example, as the transcriptionist listens to the audio signal and enters words into the graphical user interface 400, the appropriate textual placeholders 406 are filled with the entered text.

In some examples, the words or phrases entered by the transcriptionist can be compared to a predicted word that is the result of the underlying speech recognition or wordspotting algorithms. If the comparison shows a significant difference between the predicted word and the entered word, an indication of a possible erroneous text entry can be presented to the transcriptionist. For example, the word can be displayed in bold red letters.

In other examples, the transcriptionist may neglect to enter text that corresponds to one of the textual placeholders 406. In such examples, the textual placeholder 406 may remain unfilled and an indication of a missed word can be presented to the transcriptionist. For example, the underscore representing the textual placeholder 406 can be displayed as a bold red underscore. Conversely, if a transcriptionist enters text that does not correspond to any textual placeholder 406, the graphical user interface 400 can display the entered text as bold red text without any underscore, indicating that the entered text may be extraneous.

The transcriptionist using the graphical user interface 400 can revisit portions of the transcription template 412 that are indicated as possible errors and correct the entered text if necessary. For example, the transcriptionist can use a pointing device to position a cursor over a portion of entered text that is indicated as erroneous. The portion of the audio signal corresponding to the erroneous text can then be replayed to the transcriptionist. Based on the replayed portion of the audio signal, the transcriptionist can correct the erroneous text or indicate to the graphical user interface 400 that the originally entered text is not erroneous.

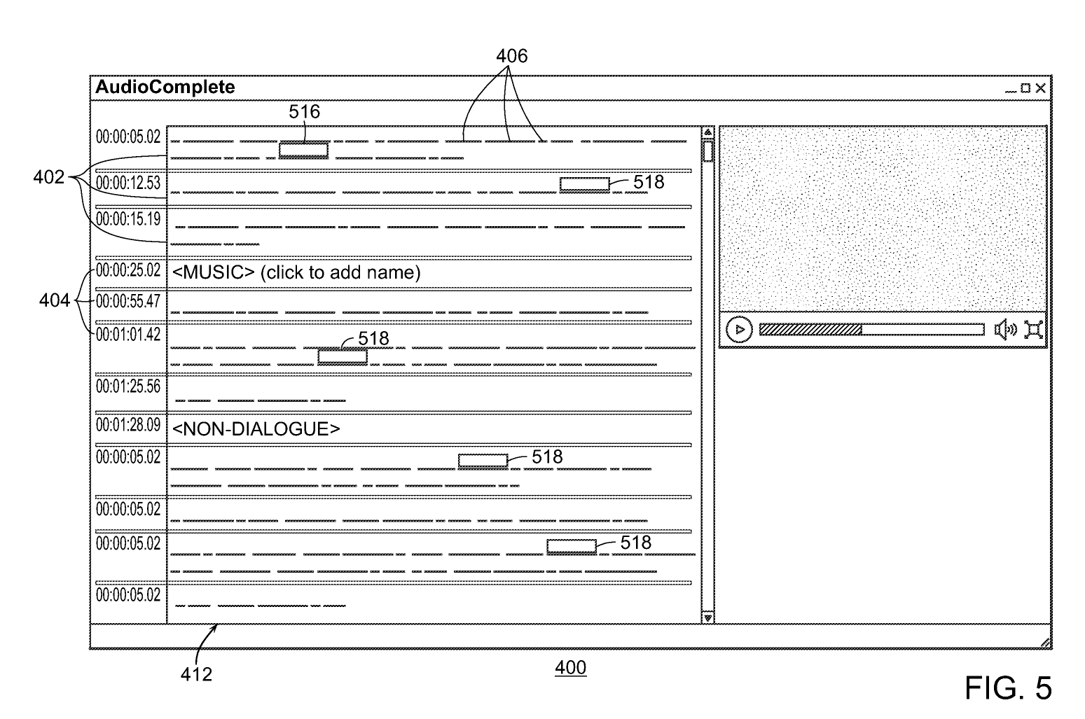

Referring to FIG. 5, another example of a graphical user interface 400 is similar to the graphical user interface of FIG. 4. An audio signal is analyzed by underlying speech processing and wordspotting algorithms, producing a number of blocks 402 which include textual placeholders 406.

In this example, as a transcriptionist is transcribing the audio, the underlying speech processing and wordspotting algorithms are configured to continually look ahead to identify words or phrases (e.g., using a phonetic search) that are present at multiple locations in the audio signal and fill in the textual placeholders 406 of the transcript which contain those words or phrases. For example, a word associated with a first textual placeholder 516 may also be associated with a number of subsequent textual placeholders 518. Thus, when a transcriptionist enters text for the word into the first textual placeholder 516, each subsequent textual placeholder 518 is populated with the text entered by the transcriptionist. In some examples, errors can be avoided by considering only long words (e.g., 4 or more phonemes) and/or with high phonetic scores. For longer phrases (or out of vocabulary phrases) this could help accelerate the transcription process.

This concept can also apply to portions of the audio signal that do not include dialogue. For example, a music detector can detect that multiple instances of a clip of music are present in the audio signal. The graphical user interface 400 represents each of the instances of the clip of music as a <MUSIC> block 408 in the template 412. When a user of the graphical user interface 400 updates metadata associated with one of the <MUSIC> blocks 408 (e.g., the name of a song), the graphical user interface 400 can automatically update all instances of that <MUSIC> block with the same metadata. In some examples, a <MUSIC> block, including metadata can be stored in a clip-spotting catalog and can be automatically used when the same <MUSIC> block is identified in future transcript templates 412.

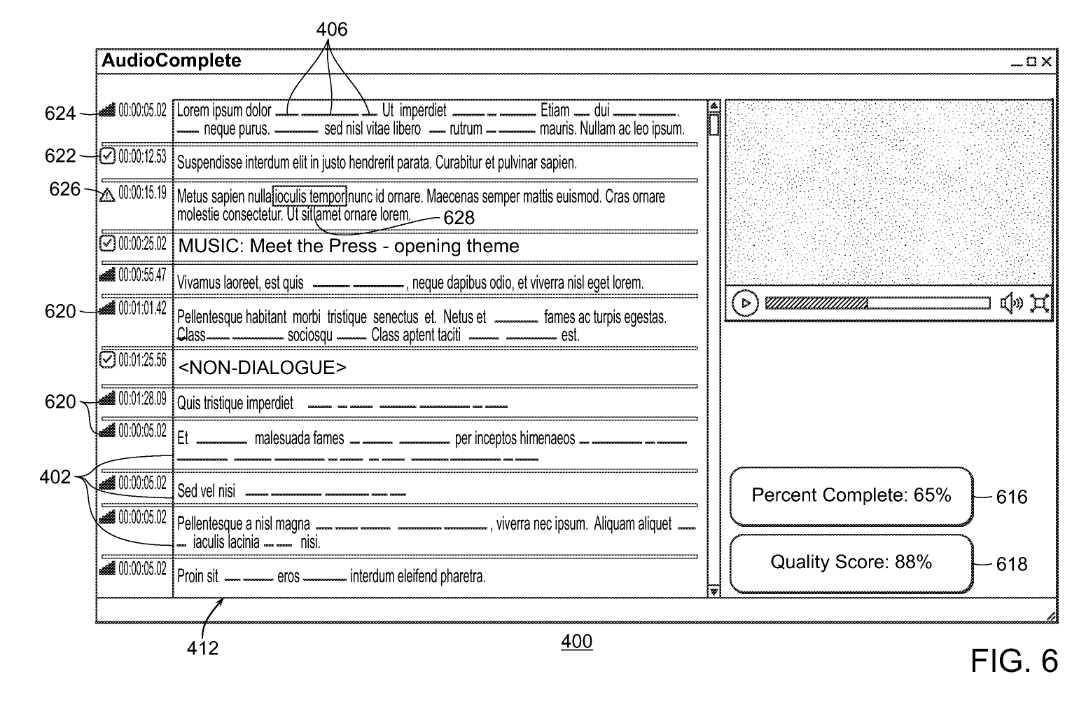

Referring to FIG. 6, a graphical user interface 400 utilizes a combination of an underlying speech to text (STT) algorithm and human input to transcribe an audio signal into textual data. In some examples, the STT algorithm is trained on a restricted dictionary that contains mostly structural language and a limited set of functional words. The STT algorithm can use out-of-grammar (OOG) or out-of-vocabulary (OOV) detection to avoid transcribing words that the algorithm is not sure of (e.g., the word has a low phonetic score).

The result of the STT algorithm is a partially complete transcript including textual placeholders 406 for words or phrases that were not transcribed by the STT algorithm. It is then up to a transcriptionist to complete the transcript by entering text into the textual placeholders 406. In some examples, the transcriptionist can use an input device to navigate to an incomplete textual placeholder 406 and indicate that they would like to complete the textual placeholder 406. In some examples, the user interface 400 then plays the portion of the audio signal associated with the textual placeholder 406 back to the transcriptionist, allowing them to transcribe the audio as they hear it. If the STT algorithm has a reasonable suggestion for the text that should be entered into the textual placeholder 406, it can present the suggestion to the transcriptionist and the transcriptionist can accept the suggestion if it is correct.

In some examples, the graphical user interface 400 can present indicators of the completeness and quality 616, 618 of the transcription to the transcriptionist. For example, the indicator of transcription completeness 616 can be calculated as a percentage of the words or phrases included in dialogue blocks 402 that have been successfully transcribed. For example, if 65% of the dialogue in the dialogue blocks 402 is transcribed and 35% of the dialogue is represented as textual placeholders 406, then the completeness indicator would be 65%. The quality indicator 618 can be determined by analyzing (e.g., by a phonetic search) each word or phrase in the incomplete transcript generated by the STT algorithm. In some examples, an overall quality score is generated for each block 402 of dialogue and the overall quality indicator 618 is calculated as an average of the quality score of each block 402. The quality indicator 618 can include coverage percentage, phonetic score, etc.

In addition to the quality and completeness indicators 616, 618, a number of other visual indicators can be included in the graphical user interface 400. For example, each block 402 may have a status marker 620 associated with it to enable transcriptionists to quickly determine the transcription status of the block 402. If a block 402 is complete (e.g., no incorrect words and no incomplete textual placeholders 406), a check mark 622 may be displayed next to the block 402. If a block 402 includes incomplete textual placeholders 406, an indication of how much of the block has been transcribed such as a signal strength icon 624 (e.g., similar to that seen on a cell phone) can be displayed next to the block 402. If a block 402 includes words or phrases that may be incorrectly transcribed, a warning symbol 626 (e.g., an exclamation point) can be displayed next to the block 402 and the words or phrases in question can be indicated (e.g., by color, highlighting, etc.) 628.

In some examples, closed captioning, non-speech events are captured and presented to a viewer. As a pre-process to transcription, these detectors could “decorate” the transcript template (see above). This information would be valuable to the transcriptionist to get a bigger picture of what's in the audio.

In some examples, the transcription system can use combined audio/video data to transcribe the audio. For example, the audio signal is analyzed to separate speakers and the video signal is analyzed to separate faces. Each speaker is automatically represented as “Speaker #1”, “Speaker #2”, etc. Each face is automatically represented as “Face #1”, “Face #2”, etc. The system analyzes the overlapping occurrences of faces/speakers to suggest which face might be speaking This correspondence can then be used to identify dialogue which is happening off-screen. Even without identifying the speakers or faces, this information could be valuable to those reviewing the content. As the user identifies faces and/or speaker, the system could begin suggesting who is speaking based on the statistics between what speaker is being heard and what faces are on screen during that time. As the user “accepts” or “rejects” these suggestions, statistical models can be influenced to increase accuracy of future suggestions. At any point even prior to the user accepting suggestions, the mapping between faces and speakers can be used to provide additional information to the user.

In some examples, the system uses the graphical user interface 400 to present suggested words to the transcriptionist as they type. For example, the word that the system determines is most likely to occupy a textual placeholder 406 could be presented to the user in gray text as they type. To accept the suggested word, the user could hit a shortcut key such as the “Enter” key or the “Tab” key. If the user disagrees with the system's suggestion, they can continue typing and the suggestion will disappear.

In other examples, the system uses the graphical user interface 400 to present a list of suggested words to the transcriptionist as they type. The transcriptionist can use an input device such as a keyboard or mouse to select a desired word from the list or continue typing to type a different word.

In some examples, the transcription system can detect missing words and/or words that are entered in an incorrect order. For example, if a transcriptionist were to enter the text “dream I have a,” the transcription system could analyze all permutations of the words in the text to come up with the most likely combination of the words in the text: “I have a dream.”

In some examples, previously completed transcripts can be used to influence or train the language model that is used to automatically process an audio signal.

In some versions the system is particularly adapted to transcription of a “new” language. A new language may range from a dialect of a known language (e.g., a dialect of Mandarin) to a new language of a known language group (e.g., a Niger-Congo language). In some examples, the approaches assume that there is at least some, possibly only approximate, mapping of lexical representations to sequences of labeled acoustic or phonetic units, which are generally referred to as pronunciation data. The pronunciation data may include letter-to-sound rules, which may be augmented by a dictionary of known words. In an early stage of transcription of a new language, acoustic models of acoustic or phonetic units from another language or dialect or from some universal set may be used.

The task for a transcriptionist of a new language is similar to that described above for a known language. In an example implementation, the transcriptionist is presented a template (frame) representation that may include indications of areas of speech, or other acoustic content (e.g., music, speaker or speaker change labeling etc.). The transcriptionist proceeds with text entry of the transcription of an initial portion of the audio recording. In examples where at least a rudimentary text-to-sound rule and/or dictionary is available, techniques such as automatic control of playback speed can be used as described above.

As the new language is transcribed, certain words may reoccur in the recording. These reoccurrences are identified by the system and presented in the template in their appropriate time-based locations. The reoccurrences of words may be detected using one or more of the following techniques in which a transcribed occurrence of a word is located at future locations: (1) waveform-based matching, for example, using a warping and acoustic matching approach, or using techniques such as described in co-pending U.S. application Ser. No. 12/833,244, titled “Spotting Multimedia,” which is incorporated by reference; (2) matching of sequences of PAT files, such that a future occurrence is matched according to the time evolution of the distribution of scores for the phonetic units (e.g., as described in co-pending U.S. application Ser. No. 10/897,056, titled “Comparing Events In Word Spotting,” which is incorporated herein by reference; and (3) by wordspotting approaches as described above for use with a known language in which the lexical form of the word is mapped to a sequence of subword units and is located using a PAT file analysis of the audio. When the user reaches the locations of such repeated words, the user can select the words, thereby accelerating transcription.

During the transcription process, periodic or continuous improvement of the text-to-sound model or dictionary and/or the acoustic models may be performed. Examples of such improvement may include one or more of the following: (1) addition of transcriber provided dictionary entries (e.g., pronunciations) for words encountered in the transcription; (2) update of text-to-sound rules, for example, based on statistical re-estimation to better match the transcribed sections and the acoustics encountered in those sections; and (3) update or re-estimation of acoustic models for the subword units used to represent the words.

Therefore, the transcription phase may be performed iteratively, with the end of this transcription phase not necessarily being distinct from the beginning of the training phase for the new language. The training for the new language is performed in a bootstrapping manner with successively more transcribed data from the new language improving models and thereby accelerating the transcription process itself.

In another example of such transcription of new languages, the role of the transcriptionist may be distributed and collaborative. For example, multiple transcriptionists may receive overlapping or distinct segments of audio recording for the new language. Each transcriptionist's frame in which they enter text may be populated using information from other transcriptionists who have transcribed the same or different portions of the recording. In some examples, the partial transcription is shared through a central server, such that each transcriptionist's partial transcription is used to populate the transcription frame of other transcriptionists. The level of granularity of such distribution of the transcription may range from the scale of words, sentences, or multi-sentence passages, to extended (e.g., 30 minute) recordings.

The approach described above may be implemented in hardware and/or in software, for example, using a general purpose computer processor, with the software including instructions for the computer processor being stored on a machine-readable medium, such as a magnetic or optical disk.

It is to be understood that the foregoing description is intended to illustrate and not to limit the scope of the invention, which is defined by the scope of the appended claims. Other embodiments are within the scope of the following claims.

What is claimed is:

1. A method for transcribing audio for a language comprising:
accepting an audio recording of spoken content from the language;
accepting pronunciation data and acoustic data for use with the language;
accepting a partial transcription of the audio recording;
identifying one or more repetitions of one or more portions of the partial transcription in the audio recording;
presenting a representation of the audio recording, the representation of the audio recording including a representation of the partial transcription and a representation of the repetitions in the recording; and
accepting a command to indicate at least one of the repetitions as a further partial transcription of the audio recording.

2. The method of claim 1 comprising providing a user interface to a transcription system, and where the accepting of the partial transcription, presenting the representation of the audio recording, and/or accepting the command to indicate at least one of the repetitions are performed using the user interface.

3. The method of claim 1 wherein accepting the pronunciation data and the acoustic data includes configuring a transcription system according to said data.

4. The method of claim 1 wherein the pronunciation data and/or the acoustic data is associated with another dialect of a language, another language from a language group, or is not specific to a language.

5. The method of claim 1 further comprising:
prior to completing transcription of the audio recording, using the partial transcription to update at least one of the pronunciation data and the acoustic data for use in further transcription of the audio data.

6. The method of claim 1 further comprising:
controlling timing of acoustic presentation of the audio recording according to timing of the accepting of the partial transcription using the pronunciation data and the acoustic data for use with the language.

7. A system for transcribing audio for a language comprising:
an input configured to accept an audio recording of spoken content from the language;
an input configured to accept pronunciation data and acoustic data for use with the language;
an input configured to accept a partial transcription of the audio recording;
a speech processor configured to identify one or more repetitions of one or more portions of the partial transcription in the audio recording;
a user interface module configured to present a representation of the audio recording, the representation of the audio recording including a representation of the partial transcription and a representation of the repetitions in the recording; and
an input configured to accept a command to indicate at least one of the repetitions as a further partial transcription of the audio recording.

8. The system of claim 7 further comprising a transcription system user interface, and where the transcription system user interface is configured to accept the partial transcription, present the representation of the audio recording, and/or accept the command to indicate at least one of the repetitions are performed using the transcription system user interface.

9. The system of claim 7 wherein the pronunciation data and/or the acoustic data is associated with another dialect of a language, another language from a language group, or is not specific to a language.

10. The system of claim 7 wherein the system is configured to, prior to completing the transcription of the audio recording, use the partial transcription to update at least one of the pronunciation data and the acoustic data for use in further transcription of the audio data.

11. The system of claim 7 wherein the system is configured to control timing of acoustic presentation of the audio recording according to timing of the accepting of the partial transcription using the pronunciation data and the acoustic data for use with the language.

12. Software stored on a computer-readable medium comprising instructions for causing a data processing system to:
accept an audio recording of spoken content from the language;
accept pronunciation data and acoustic data for use with the language;
accept a partial transcription of the audio recording;
identify one or more repetitions of one or more portions of the partial transcription in the audio recording;
present a representation of the audio recording, the representation of the audio recording including a representation of the partial transcription and a representation of the repetitions in the recording; and
accept a command to indicate at least one of the repetitions as a further partial transcription of the audio recording.

13. The software of claim 12 further comprising instructions for causing the data processing system to provide a user interface to a transcription system, and where the accepting of the partial transcription, presenting the representation of the audio recording, and/or accepting the command to indicate at least one of the repetitions are performed using the user interface.

14. The software of claim 12 wherein the instructions for causing the data processing system to accept the pronunciation data and the acoustic data include instructions for causing the data processing system to configure a transcription system according to said data.

15. The software of claim 12 wherein the pronunciation data and/or the acoustic data is associated with another dialect of a language, another language from a language group, or is not specific to a language.

16. The software of claim 12 further comprising:
instructions for causing the data processing system to, prior to completing transcription of the audio recording, use the partial transcription to update at least one of the pronunciation data and the acoustic data for use in further transcription of the audio data.

17. The software of claim 12 further comprising:
instructions for causing the data processing system control timing of acoustic presentation of the audio recording according to timing of the accepting of the partial transcription using the pronunciation data and the acoustic data for use with the language.
